(19) United States
(12) Patent Application Publication
(10) Pub. No.: US 2003/0073361 A1
(43) Pub. Date: Apr. 17, 2003

(54) Process to manufacture novel abrasive belt substrate

(76) Inventors: Steven A. Stansell, Spartanburg, SC (US); Charles R. Tidd IV, Simpsonville, SC (US); Wilson L. Strom JR., Eagan, MN (US)

Correspondence Address: Terry T. Moyer, P.O. Box 1927, Spartanburg, SC, 29304, US

(21) Appl. No.: 09/976,777

(22) Filed: Oct. 12, 2001

(51) Int. Cl. B32B 1/00; B32B 5/02; B32B 27/04; B32B 27/12; D06N 7/04; D03D 15/00; D03D 25/00

(52) U.S. Cl. 442/101; 428/144; 428/143; 442/181

(57) ABSTRACT

A process to produce a novel substrate for adherence to a product such as an abrasive belt which encompasses the use of a woven product in the greige state that has open-end, staple cellulosic yarn which has been prewet slashed before weaving.

This invention relates to a novel cellulosic substrate for industrial belts such as abrasive and conveyor belts which is inexpensive to manufacture and provides improved performance when mated with the ultimate belt product.

In the past substrate fabrics for industrial belts were woven fabrics which employed ring spun yarns which were sized before weaving that required washing after weaving to reduce stiffness and improve adhesion characteristic for coating. The use of such ring spun fabrics was relatively expensive and required the additional step of washing after weaving thereof.

It is therefore an object of the invention to provide a new and improved industrial substrate fabric which is inexpensive to manufacture and provides increased absorption characteristics and higher adhesion to coatings for adhesion to the industrial belt.

Another object of the invention is to provide an open end spun, cellulosic yarn for industrial substrate fabrics which is cheaper and eliminates the necessity of washing after weaving.

Other objects and advantages of the invention will become readily apparent as the specification proceeds to describe the invention in reference to the accompanying drawing; in which:

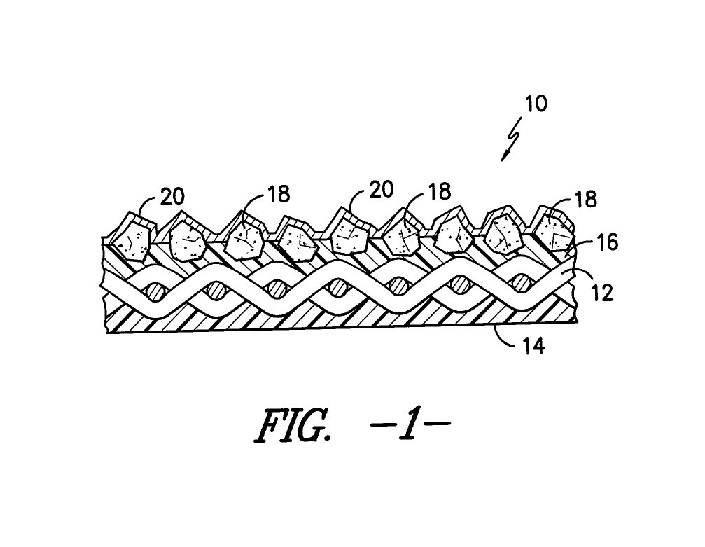

FIG. 1 is a cross-sectional view of the new and improved substrate adhered to an abrasive belt and

FIGS. 2-4 is schematic representations of the new and improved process and

Looking now to FIG. 1, the reference numeral 10 represents the preferred use of the new and improved substrate in which is an abrasive belt for sanding, grinding, polishing, etc. of a desired product. The belt 10 basically consists of the woven substrate 12 of open end spun cellulosic fibers such as rayon, rayon modifications such as lyocel, cotton, or other cellulosic yarns,; a back sizing material 14 such as a phenolic resin to provide firmness; another face sizing 16 of phenolic resin to provide good adhesion to the abrasive particles 18 and an acrylic protective coating 20 over the abrasive product 18.

Currently, the process of manufacturing the abrasive belt is a three-step process as indicated in FIGS. 2-4, but if desired, the steps or some of the steps can be combined to reduce costs.

In FIG. 2 100%, 1.2 denier per filament, staple lyocel fibers are spun in a conventional open end spinning machine 22 into a 22.5, cotton count, lyocel yarn 23 for use in the warp and fill of the hereinafter described woven fabric 12 and the warp yarn 23 is taken up on a warp beam 24 while the fill yarn remains on bobbins.

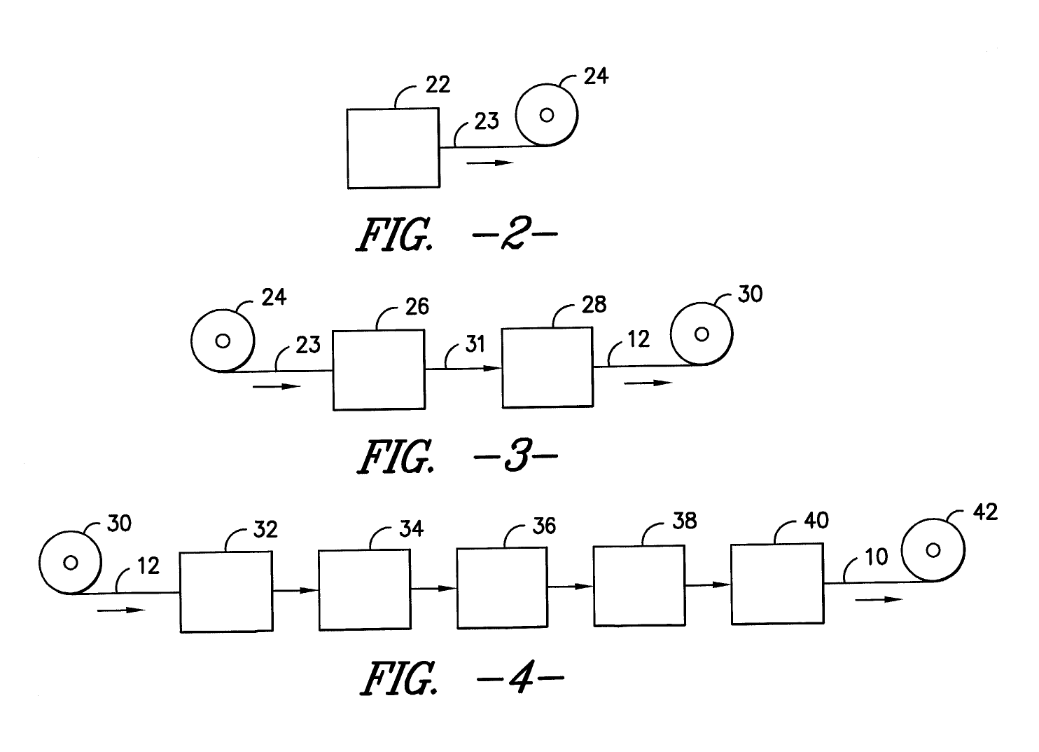

The warp beam 24 in FIG. 3 supplies yarn 23 therefrom into a prewet slasher 26 from whence it is delivered to loom or weaving machine 28 and woven into the fabric 12, which is taken up on the beam 30. Preferably, the slasher 26 consists of two boxes with the yarn 23 having saturated with water in the first box so that the add-on of PVA sizing in the second box is only 2-4%, preferably 3%, versus the traditional 6-12% add-on. By % add-on is meant the amount of dry size on the yarn expressed as a percentage of the dry weight of the unsized yarn.

The slasher 26 provides an open end spun cellulosic yarn 31 which only has sizing material on the surface thereof which does not need the additional step of washing after being woven into the fabric 12. The presaturation of the yarn 23 in the first box of the slasher reduces the amount of size add-on, necessary to hold the yarn together in the weaving process. The woven yarn 12 is then taken-up on the beam 30 without washing and supplied for further processing as in FIG. 4.

The fabric 12 is produced on a Sauer weaving machine to provide a 63 inch fabric having 96 ends per inch and 64 picks per inch with a weight of 9.3 ounces per linear yard. This is the preferred fabric that is used in the greige state for coated abrasive belts, but, depending on its construction and use, can have 20-80 picks per inch with 45 to 120 ends per inch with a weight of 3.0 to 16.0 oz per square yard. As indicated the warp and weft yarns are 22.5 cotton count, but can vary from 6.0 to about 36.0 cotton count.

After the greige fabric 12 has been taken up on the roll 30 the roll 30 is ready to be treated to produce the desired product which in the preferred embodiment is the abrasive belt 10 in the manner shown in FIG. 4. In sequential steps the fabric 12 is dyed and saturated at 32 to provide color and stiffness thereto and then back sized at 34 with a phenolic resin to provide firmness to the back thereof and pre-sized at 36 on the face thereof with another phenolic resin to provide adhesiveness thereto. Then, the sized fabric is coated at 38 with abrasive material 18 and coated at 40 with an acrylic protective coating 20. Then the completed abrasive belt 10 is taken up on a take-up roll 42.

As herein described above process has been described which employs a relatively inexpensive, stable open end spun yarn that provides a woven greige fabric which does not require the additional steps of washing after weaving and which is used in the greige state to provide a flexible, high strength coated belt product such as an abrasive belt. As disclosed the preferred yarn is an improved rayon but other cellulosic fibers such as cotton can be employed within the scope of the invention.

Other advantages and modifications of the invention are inherent in the disclosed embodiment described above and therefore it is understood the invention is limited to such embodiment and it is requested that the invention therefore be limited by the claims.

What is claimed is:

1. A woven substrate for high strength, flexible belt type products comprising: a greige woven fabric having warp and weft yarns, said warp yarns have substrates open-end spun cellulosic staple yarns and said warp yarns being pre-wet slashed prior to weaving.

2. The substrate of claim 1, wherein said weft yarns are substantially open-end, staple fiber cellulosic yarns.

3. The substrate of claim 1, wherein said woven fabric has 45 to about 120 ends per inch.

4. The substrate of claim 1, wherein said woven fabric has 20 to about 80 picks per inch.

5. The substrate of claim 4, wherein said woven fabric has about 45 to 120 ends per inch.

6. The substrate of claim 5, wherein said fabric has a weight of 3.0 to about 16.0 ounces per square yard.

7. The substrate of claim 1, wherein said fabric has a weight of 3.0 to about 16.0 ounces per square yard.

8. The substrate of claim 1, wherein said warp and weft yarns are rayon type or blends thereof.

9. The substrate of claim 1, wherein said warp and weft yarns are cotton blends thereof.

10. The substrates of claim 1, wherein said woven fabric is united with another material to form a desired product.

11. The combination of claim 10, wherein said other material is an abrasive.

12. The combination of claim 11, wherein said abrasive is coated with an acrylic.

13. The substrate of claim 11, wherein said weft yarns are substantially open-end, staple cellulosic yarns.

14. The substrate of claim 11, wherein said fabric has a weight of 3.0 to about 16.0 ounces per square yard.

15. The process of producing a strong flexible substrate comprising the steps of: open-end spinning cellulosic staple fibers into a yarn, pre-wet slashing said cellulosic yarn to coat sizing only on the surface of said yarn, weaving said pre-slashed yarn into a fabric and supplying the fabric to a take-up without washing thereof.

16. The process of claim 15, wherein said cellulosic yarn is a rayon.

17. The process of claim 16, wherein said woven fabric is coated with an abrasive material to form an abrasive belt.

18. The process of claim 17, wherein said abrasive material is coated with an acrylic.

19. The product produced by the process of claim 15.

20. An abrasive belt product comprising: a woven substrate with abrasive particles adhered thereto, said woven substrate having cellulosic, open end spun yarn in the warp and fill directions with the woven substrate being sized to retain the abrasive particles and said abrasive products being coated with an acrylic.
